(19) United States
(12) Patent Application Publication
(10) Pub. No.: US 2004/0007088 A1
(43) Pub. Date: Jan. 15, 2004

(54) Connecting rod assembly

(76) Inventor: David C. Swenson, Spring Lake, MI (US)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/614,271

(22) Filed: Jul. 7, 2003

Related U.S. Application Data
(60) Provisional application No. 60/395,323, filed on Jul. 12, 2002.

(51) Int. Cl. G05G 1/00

(52) U.S. Cl. 74/593

(57) ABSTRACT

A connecting rod assembly that is provided with an integral pre-set tension that is helpful in the use of the connecting rod assembly when installed in an internal combustion engine.

### BACKGROUND OF THE INVENTION

This application claims priority from provisional applications filed on Jul. 12, 2002 as U.S. S No. 60/395,323 and The invention disclosed and claimed herein deals with a connecting rod assembly that is intended to provide an integral pre-set tension within the connecting rod assembly that is helpful in the use of the rod assembly when installed in an internal combustion engine.

The inventor is aware of connecting rod assemblies such as disclosed in U.S. Pat. No. 4,836,045 issued Jun. 6, 1989 to Lobig, wherein a multi-piece connecting rod is formed by two rods combined wherein a crank pin bearing boss is split along an axial plane through its bearing axis. The rods are joined around the crank pin to form the bearing boss and the rod assembly.

### BRIEF DISCRIPTION OF THE INVENTION

The invention is a piston rod assembly comprised of two nearly symmetrical rods, of equivalent size, both manufactured of modified metal, having a near and distal end and an essentially inside flat wall surface. The distal end of each rod terminates in an arcuate configuration forming a circle when the rods are joined. The near end of each rod terminates in an arcuate configuration such that upon joining the rods together the arcuate configurations form a second circle. The arcuate configuration itself has a near end and a distal end and each distal end has an opening at the terminus thereof to receive a fastening device. The beam between the near and distal end also encompasses another opening, between the two circles formed by combining the two rods into the assembly. As one embodiment, this opening contains an integral pre-set loading tension feature consisting of a threaded bolt. The bolt places both compression and tension forces on the beam when the rod assembly is installed and there are no outside forces operating upon it. The stress created depends on the shape of the beams and the size of the gap between the beams. Additionally, compression stress in the metal of the rods is accomplished by the use of methods known in the art such as high pressure water treatment, shot peening, ion bombardment or chemical treatment of the surface of the metal of the rod. What is meant by “modified metal” in this invention is metal that has been so treated. This metal modification when used in combination with the threaded bolt, and the thickness of the metal surrounding the opening in the assembly, is what creates the desired compression in the rod assembly.

### BRIEF DISCRIPTION OF THE DRAWINGS

FIG. 1 is a fill exploded view of the connecting rod assembly in perspective.

FIG. 2 is a full assembled front view of the connecting rod assembly without the bushings.

FIG. 3 is a full side view of the connecting rod assembly.

FIG. 4 is an enlarged view of point A of FIG. 2 showing the gap formed internally upon the assembly of the rods.

### THE INVENTION

The invention disclosed and claimed herein deals with a connecting rod assembly that is provides an integral pre-loading of the beams within the connecting rod assembly.

With more specificity, the invention is a connecting rod assembly comprised of two symmetrical rods, each comprised a central beam of equivalent size, each having a near and a distal end, and an inside, essentially flat wall surface. Each distal end of each beam terminates in an arcuate configuration that forms a circle when the two rods are joined. Each near end of each beam terminates in another arcuate configuration such that upon joining the rods, these arcuate configurations form a second circle.

The arcuate configuration itself has a near end and a distal end and each distal end has an opening at the terminus to receive a fastening device. Each rod has an opening in the beam located between the arcuate configurations. The location of the beam opening can vary along the long axis of the rod to allow pre-adjustment of the tension within the rod assembly. All the openings are directed through the inside, essentially flat wall surface such that the rod can be assembled and held firmly together using fasteners.

### DETAILED DESCRIPTION OF THE INVENTION

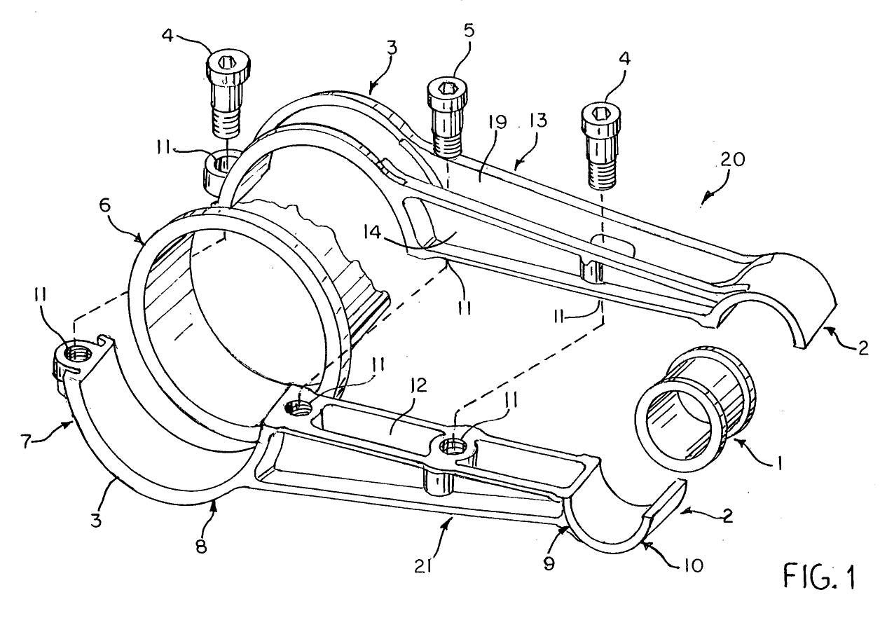

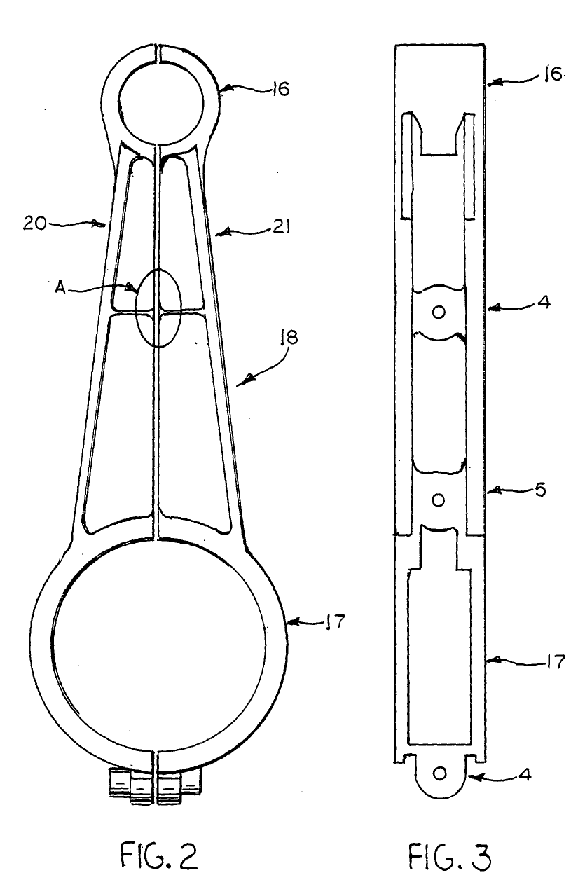

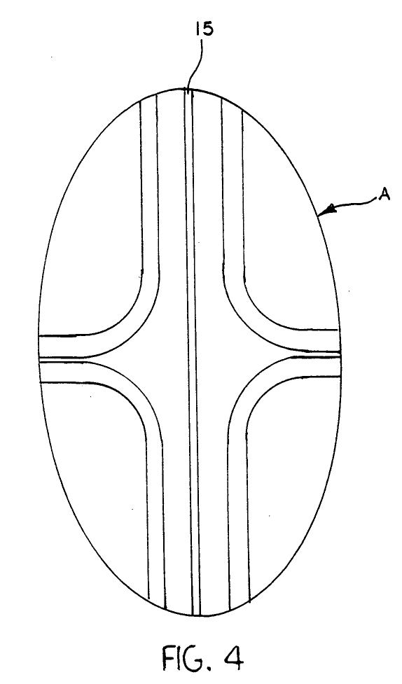

Turning now to the Figures, and with reference to FIG. 1, there is shown a rod assembly 18 that is a combination of two symmetrical beams 20 and 21; both of equivalent size, wherein the rod assembly is shown in full, exploded, perspective. There is a bushing 1 present in the first circle 2 formed by the first arcuate configuration forming the piston pin journal 16. There is a bushing 6 present in the second circle 3 formed by the second arcuate configuration forming the crank pin journal 17. The first arcuate configuration 2 has a near end 10 and the distal end 9. The fastening devices 5 on the near end 8 and distal end 7 of the second arcuate configuration 3 secure it around the crank pin (not shown). The openings 11 receive fasteners 4 and the integral pre-set loading tension feature 5 through rod assemblies 2 and 3. The inside, essentially flat wall surface 12 is where the gap 15, if any, exists once the assemblies are combined. Between the first arcuate configuration 2 and the second arcuate configuration 3 is the beam 13 and the top 19 or opposing side of wall surface 14. In FIG. 2, wherein the rods 20 and 21 are shown assembled, there is a full assembled front view of the rod assembly 18 without bushings. The first arcuate configuration 2 forms a circle 16 that acts as a piston pin journal encircling the bushing 1, which bushing 1 surrounds the piston pin (not shown). The second arcuate configuration 3 forms a circle 17 that acts as a crank pin journal encircling the bushing 6, which surrounds the crank pin (not shown). With reference to FIG. 3, there is shown a side view of rod assembly 20 and 21 in combination. It shows the fasteners 4 and the integral pre-set tension feature 5. With reference to FIG. 4, there is shown an enlarged segment of point A of FIG. 2, showing the gapI5, that can be created by the combination of rods 20 and 21. This gap 15 allows the rod assembly to bend when integral pre-stress load tension 5 is set. Capillary action within the gap 15 provides lubrication to the bushings and piston journal, although, this could be done with additional holes for that purpose.

In use, the integral pre-set loading tension feature 5 functions to squeezes the rods 20 and 21 together. This places the outside of each rod in compression, and the inside along the long rod axis, in tension. These parts generally fail in tension. Tightening the integral pre-set loading feature 5 moves the section of rod assembly 13 towards compression and the part in compression moves more into compression. The advantage to the integral pre-set loading tension feature 5 is that it will counteract the natural failure mechanism in conjunction with a comprehensive surface treatment such as high pressure water treatment, shot-peening, ion bombardment or chemical modification which places the majority of the part in compression. The adjustment is predetermined and set before the rod 18 is installed within the engine itself. This also provides a lighter weight rod assembly as compared with conventional rod assemblies primarily from turning the fasteners perpendicular to the main longitudinal axis of the beams wherein the rods are held closely around the bushings and journals, but do not take the loads of prior art devices. There is a weight reduction from the fact that the rods can be made smaller and lighter due to the pre-stressing of the beams so that they do not fail in tension due to the lighter weight. Additionally, there are lower energy requirements from not having to drag a larger rod through the lubricating oil. Also, there are reduced bearing sizes from the smaller sizing of the lighter weight components. Another advantage gained is increased clearance between the engine block and other components during and after installation. Dimensions of the rod assembly are varied to fit most conventional internal combustion engines. There is a clear advantage to the integral pre-setting because it allows the adjustment to be set by torque at various levels. Combined with the metal modification and thickness of the rod assembly 18 itself makes this a very useful revolutionary step in connecting rod assemblies.

What is claimed:

1. A rod assembly comprising;
(i) two symmetrical rods of equivalent size; each said rod manufactured of modified metal; each said rod comprising a central beam having a near end and a distal end and an inside wall surface; each distal end terminating in a first arcuate configuration; each near end terminating in a second arcuate configuration such that upon joining the rods together the first arcuate configurations form a first circle and the second arcuate configurations form a second circle; each of the arcuate configurations having a near end and a distal end wherein each distal end has an opening at the terminus thereof to receive a fastening device;
(ii) each said rod having an opening located in the central beam between the first arcuate configuration and the second arcuate configuration, wherein all openings are directed through the inside wall surface thereof.

2. A device as claimed in claim 1 wherein there is additionally present a fastening device located in each opening.

3. A device as claimed in claim 1 wherein there is present a bushing in the first circle formed by the first arcuate configurations.

4. A device as claimed in claim 3 wherein there is present a bushing in the circle formed by the second arcuate configurations.

5. A device as claimed in claim 1 wherein the rods are assembled such that there is a gap provided between the inside surface of the beams.

6. A device as claimed in claim 1 wherein the inside surface of each beam between the first and second arcuate configurations is flat.

7. A device as claimed in claim 6 wherein the inside surface of each beam contains a channel therein running essentially the length of the flat inside surface.

8. A device as claimed in claim 1 wherein the fastener in the opening located between the first arcuate configuration and the second arcuate configuration is capable of being adjusted to provide compression or tension.

9. A device as claimed in claim 1 wherein the opening located between the first arcuate configuration and the second arcuate configuration is not at the midpoint.

10. A device as claimed in claim 1 wherein the metal rods are shot peened to create compression stress in the metal rods.

11. A device as claimed in claim 1 wherein the metal rods are treated with high pressure water to create compression stress in the metal rods.

12. A device as claimed in claim 1 wherein the metal rods are chemically treated to create compression stress in the metal rods.
